(19) United States
(12) Patent Application Publication
(10) Pub. No.: US 2021/0381363 A1
(43) Pub. Date: Dec. 9, 2021

(54) RELATIVE PERMEABILITY ESTIMATION METHODS AND SYSTEMS EMPLOYING DOWNHOLE PRESSURE TRANSIENT ANALYSIS, SATURATION ANALYSIS, AND POROSITY ANALYSIS

(71) Applicant: Halliburton Energy Services, Inc., Houston, TX (US)

(72) Inventors: Abdolhamid Hadibeik, Houston, TX (US); Waqar Ahmad Khan, Houston, TX (US); Mehdi Azari, Houston, TX (US); Abbas Sami Eyuboglu, Houston, TX (US); Sandeep Ramakrishna, Cypress, TX (US)

(21) Appl. No.: 16/322,710

(22) PCT Filed: Oct. 18, 2016
(86) PCT No.: PCT/US2016/057555

§ 371 Date: Feb. 1, 2019

(51) Int. Cl. E21B 47/06; E21B 49/08; G01V 3/32

(52) U.S. Cl. CPC E21B 47/06; G01V 3/32; E21B 49/08

(57) ABSTRACT

A system includes a pressure transient analysis test tool with flow analysis components and at least one pressure sensor. The pressure transient analysis test tool collects pressure measurements for at least one target position in a borehole as a function of time and fluid flow rate. The system also includes at least one processor that receives saturation analysis results and porosity analysis results related to each target position. The processor estimates relative permeability values based at least in part on the pressure measurements, the saturation analysis results, and the porosity analysis results.

### BACKGROUND

Modern petroleum drilling and production operations demand a great quantity of information relating to the parameters and conditions downhole. Such information typically includes the location and orientation of the wellbore and drilling assembly, earth formation properties, and drilling environment parameters downhole. The collection of information relating to formation properties and conditions downhole is commonly referred to as “logging.” Logging data can be collected before hydrocarbon production begins and/or during hydrocarbon production operations (i.e., logging operations can be performed in open wellbores or cased wellbores).

Relative permeability is one parameter that helps oilfield operations to understand how fluids in a formation will flow when more than one fluid exist in the formation. As used herein, “relative permeability” refers to the permeability of a particular fluid relative to other fluids present in a formation or rock sample. One technique to determine relative permeability values involves performing laboratory tests on a rock sample or a core sample. One of the deficiencies of such laboratory tests is that the laboratory test environment does not match the downhole environment. Another relative permeability technique involves inversion by history matching of the observed flowrate and pressure from a particular section. Owing to the number of unknown variables, this technique may have a corresponding degree of uncertainty.

### BRIEF DESCRIPTION OF THE DRAWINGS

Accordingly, there are disclosed in the drawings and the following description relative permeability estimation methods and systems employing downhole pressure transient analysis, saturation analysis, and porosity analysis. In the drawings:

FIG. 1 is a block diagram showing an illustrative downhole tool assembly;

FIGS. 2A-2C are schematic diagrams showing illustrative downhole survey environments;

FIGS. 3-9 are flowcharts and graphs showing illustrative options for relative permeability estimation;

FIG. 10 is a flowchart showing an illustrative method for relative permeability estimation.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Disclosed herein are relative permeability estimation methods and systems employing downhole pressure transient analyses, saturation analysis, and porosity analysis. With the disclosed embodiments, a pressure transient analysis test tool is deployed in a borehole to collect pressure measurements as function of time and fluid flow rate for at least one target location in the borehole. Also, at least one saturation analysis tool (e.g., a resistivity logging tool, a dielectric logging tool, other electromagnetic analysis tools, and/or other tools) is deployed in the borehole to collect saturation analysis measurements for each target position. Also, at least one porosity analysis tool (e.g., a nuclear magnetic resonance logging tool and/or a neutron density logging tool) is deployed in the borehole to collect porosity analysis measurements for each target position. In some embodiments, a pressure transient analysis test tool, saturation analysis tool(s), and porosity analysis tool(s) are deployed together in a borehole as part of a logging tool assembly. In other embodiments, one or more of the pressure transient analysis test tool, saturation analysis tool(s), and porosity analysis tool(s) are deployed in the borehole separately from each other (e.g., at different times). Also, in different embodiments, downhole pressure transient analysis results, saturation analysis results, and porosity analysis results may correspond to open borehole analysis (no casing) or cased borehole analysis (e.g., after casing installation, cementing, perforating, and/or zoning operations are complete). For example, in some embodiments, only open borehole analysis results are used to estimate relative permeability values. In other embodiments, only completed borehole analysis results are used to estimate relative permeability values. In yet other embodiments, a mixture of open borehole analysis results and cased borehole analysis results are used to estimate relative permeability values. In at least some embodiments, relative permeability values are estimated based on pressure transient analysis results for each target position of the borehole in combination with saturation analysis results for each target position and porosity analysis results for each target position. As an example, the pressure transient analysis results may correspond to pressure changes for each target position in the borehole as a function of time and flow rate. Meanwhile, saturation analysis results may correspond to water saturation, oil saturation, and/or gas saturation levels for each target position in the borehole (as used herein “oil” and “gas” refer to different hydrocarbon phases that may exist together or separately). Additionally, the saturation analysis results may include identified oil zones (e.g., where oil saturation is higher than a threshold), identified gas zones (e.g., where gas saturation is higher than a threshold), identified water zones (e.g., where water saturation is higher than a threshold), identified oil/gas transition zones, identified oil/water transition zones, and identified gas/water transition zones. Meanwhile, the porosity analysis results may correspond to formation porosity for each target position in the borehole.

In at least some embodiments, the pressure transient analysis results, the saturation analysis results, and the porosity analysis results may be applied to a multi-phase flow model to estimate relative permeability values. As an example, a pressure change value obtained from pressure transient analysis, a saturation value obtained from saturation analysis, and a porosity value obtained from porosity analysis can be applied to a multi-phase flow model (e.g., a model that follows Darcy's law for multi-phase fluid flow) to estimate relative permeability values. Other parameters may be measured or estimated and applied to the multi-phase fluid model as well.

In an example embodiment, relative permeability curves are estimated by determining end points and curvature points based on pressure transient analysis results, saturation analysis results, and porosity analysis results. For example, oil permeability end points can be obtained from analysis results for an oil zone corresponding to one of the target positions in a borehole. Also, gas permeability end points can be obtained from analysis results for a gas zone corresponding to one of the target positions in a borehole. Also, water end points can be obtained from analysis results for a water zone corresponding to one of the target positions in borehole. Also, relative permeability curvature points can be determined from analysis results from a transition zone corresponding to one of the target positions borehole. For example, oil/gas relative permeability curvature points can be determined from analysis results from an oil/gas transition zone. Also, oil/water relative permeability curvature points can be determined from analysis results from an oil/water transition zone. Also, gas/water relative permeability curvature points can be determined from analysis results from a gas/water transition zone. Thus, in at least some embodiments, oil/water relative permeability curves are estimated using oil permeability end points from analysis results for an oil zone, water permeability end points from analysis results for a water zone, and oil and water permeability curvature points (between the end points) from analysis results for an oil/water transition zone. As another example, oil/gas relative permeability curves can be estimated using oil permeability end points from analysis results for an oil zone, gas permeability end points from analysis results for a gas zone, and oil and gas permeability curvature points (between the end points) from analysis results for an oil/gas transition zone. As another example, gas/water relative permeability curves can be estimated using gas permeability end points from analysis results for a gas zone, water permeability end points from analysis results for a water zone, and gas and water permeability curvature points (between the end points) from analysis results for a gas/water transition zone.

In at least one embodiment, a relative permeability is estimated using analysis results from a single zone. For such embodiments, an injection operation to create a transition zone. Once a transition zone is created, pressure transient analysis results, saturation analysis results, and porosity analysis results are used with history matching to estimate relative permeability values. For example, pressure transient analysis results can be history matched for oil/water relative permeability estimation by constraining the flow rate and observing the pressure (from the pressure transient analysis results) as well as oil and/or water cuts (from the saturation analysis results and/or porosity analysis results). As another example, pressure transient analysis results can be history matched for oil/gas relative permeability estimation by constraining the flow rate and observing the pressure (from the pressure transient analysis results) as well as the oil and/or gas cuts (from the saturation analysis results and/or porosity analysis results). As another example, pressure transient analysis results can be history matched for gas/water relative permeability estimation by constraining the flow rate and observing the pressure (from the pressure transient analysis results) as well as the gas and/or water cuts (from the saturation analysis results and/or porosity analysis results).

In different embodiments, the estimated relative permeability values are output and/or are used for different types of hydrocarbon (oil and/or gas) field exploration operations and/or hydrocarbon field production operations. As an example, the estimated relative permeability values can be output to a computer or printer (e.g., as relative permeability curves) for review/analysis by individuals or teams that make decisions regarding hydrocarbon reservoir management. Example decisions include production management options, zone management options, and enhanced oil recovery management options. Additionally or alternatively, at least some of the estimated relative permeability values can be provided as inputs to a reservoir simulator that predicts fluid flow. With or without user review/input, the reservoir simulator results and/or the estimated relative permeability values can be used to adjust the operations of downhole components related to well completion, well intervention, and hydrocarbon production components. Example components that can be adjusted or directed based on the estimated relative permeability values or related results include directional drilling components, downhole logging tools, well completion tools, well intervention tools, sensors, valves, flow control components, pumps, etc.

In at least some embodiments, an example system includes a pressure transient analysis test tool configured to obtain downhole pressure transient analysis results for at least one target position of a borehole, the pressure transient analysis test tool having at least one flow analysis component and at least one pressure sensor. The downhole pressure transient analysis results are based on fluid flow rate measurements collected by the at least one flow analysis component for each target position and are based on pressure measurements collected by the at least one pressure sensor for each target position. The system also includes at least one memory that stores relative permeability estimation instructions, the pressure transient analysis results, saturation analysis results for each target position, and porosity analysis results for each target position. The system also includes at least one processor in communication with the at least one memory, wherein the relative permeability estimation instructions cause the at least one processor to estimate relative permeability values based at least in part on the pressure transient analysis results, the saturation analysis results, and the porosity analysis results.

Another example system includes a processor and at least one memory in communication with the processor and storing relative permeability estimation instructions, pressure transient analysis results for at least one target position of a borehole, saturation analysis results for each target position, and porosity analysis results for each target position. The relative permeability estimation instructions cause the processor to estimate relative permeability curves based at least in part on the pressure transient analysis results, the saturation analysis results, and the porosity analysis results. The system also comprises an output that displays the estimated relative permeability curves.

Meanwhile, an example method includes obtaining pressure transient analysis results for at least one target position of a borehole. The method also includes obtaining saturation analysis results for each target position. The method also includes obtaining porosity analysis results for each target position. The method also includes estimating, by at least one processor, relative permeability values based at least in part on the pressure transient analysis results, the saturation analysis results, and the porosity analysis results.

In at least some embodiments, the proposed relative permeability estimation options replace inversion with a direct measurement of relative permeability (using downhole tool measurements and a multi-phase fluid flow model). In other embodiments, inversion is used with a reduced number of unknown variables. For example, one way to reduce the number of unknown variables for inversion involves injecting fluids into a formation up to a known invasion radius. Thereafter, the flow response is analyzed to invert for relative permeability. The intentional creation of an invaded zone of a known radius allows for reduction in the number of unknown variables thus allowing the inversion technique to be carried out with a higher degree of confidence.

The disclosed methods and systems are best understood when described in an illustrative usage context. FIG. 1 is a block diagram showing an illustrative downhole tool assembly 2. In at least some embodiments, the downhole tool assembly 2 includes a pressure transient analysis test tool 4 with flow analysis components 6 and pressure sensor(s) 8. The flow analysis components 6 may include sensors for measuring flow rate. In different embodiments, the flow analysis components 6 may also include components for pumping fluid into and/or pumping fluids from a formation. Also, the flow analysis components 6 may include components that extend a conduit to a borehole wall and/or that provide a seal between the tool and a formation to facilitate pressure transient analysis operations. In operation, the pressure transient analysis test tool 4 collects pressure measurements as function of time and fluid flow rate for at least one target position in a borehole. The pressure measurements and/or other pressure transient analysis results are one of the inputs to estimate relative permeability as described herein.

The downhole tool also includes logging tools 10, including saturation analysis tool(s) 11 and porosity analysis tool(s) 12. Example saturation analysis tools 11 include resistivity logging tools and dielectric logging tools. Such tools operate by transmitting electromagnetic signals into a downhole formation and receiving related signals that have travelled through a region of investigation of the downhole formation. The difference between attributes of the transmitted signal (e.g., amplitude, phase, frequency) relative to the attributes of the received signals (e.g., amplitude, phase, frequency, and/or travel time can be considered) can be used to identify formation properties such as resistivity, conductivity, and/or a dielectric constant. Also, these formation properties can be correlated with the presence of fluids (e.g., oil, water, or a mixture) in the downhole formation. Other saturation analysis tools are possible. Regardless of the particular saturation analysis tool used, the saturation analysis results obtained by deploying saturation analysis tool(s) 11 in a borehole may include water saturation levels, oil saturation levels, gas saturation, identified oil zones, identified water zones, identified gas, identified oil/water transition zones, identified oil/gas transition zones, identified gas/water transition zones, and/or other results.

The logging tools 10 may also include porosity analysis tools 12. Example porosity analysis tools 12 include nuclear magnetic resonance (NMR) logging tools and neutron density logging tools. NMR logging tools operate by establishing a static electromagnetic (EM) field in a region of investigation in a downhole formation and periodically emitting a pulse EM field that causes atoms of one or more elements to spin. The spin echo is a detectable electromagnetic phenomenon that can be correlated with a volume of one or more elements in the region of investigation. Meanwhile, neutron density logging tools operate, for example, using a neutron source and a gamma ray detector. The amount of gamma rays detected can be correlated with the presence of one or more elements in a region of investigation of a downhole formation. Other porosity analysis tools are possible. Regardless of the particular porosity analysis tool used, the porosity analysis results obtained by deploying porosity analysis tool(s) 12 in a borehole may include porosity in the region of investigation, a volume of particular elements in the region of investigation, or other results. Additionally, other logging tools may provide results that can be taken into account when estimating relative permeability values. In different embodiments, the results of different logging tools can be combined or correlated together to determine estimates for formation parameters of interest such as water saturation levels, oil saturation levels, gas saturation levels, oil zones, water zones, gas zones, oil/water transition zones, oil/gas transition zones, gas/water transition zones, and/or porosity.

Different embodiments of the logging tool assembly 2 are possible. For example, in one embodiment, the logging tools 10 are omitted (separate deployment is possible). In another embodiment, the pressure transient analysis test tool 4 and the logging tools 10 are within a single tool body. In another embodiment, the pressure transient analysis test tool 4 and the logging tools 10 of the logging tool assembly 2 are distributed across a plurality of tool bodies. The plurality of tool bodies of the logging tool assembly 2 can be coupled to each other directly or indirectly. Also, the coupling of tool bodies can be rigid or flexible. For example, in a logging-while-drilling scenario, a rigid coupling between tool bodies is needed. Meanwhile, in a wireline logging scenario, a rigid or flexible coupling between tool bodies may be used. The coupling components between tool bodies of the logging tool assembly 2 may be, for example, a wireline, an umbilical, a slick line, coiled tubing, metallic tubulars (drillstring or casing segments), wired tubulars, or other couplers.

As shown in FIG. 1, the logging tool assembly 2 also includes data storage 14 for storing measurements collected by the pressure transient analysis tool 4 and/or the logging tools 10. The data storage 14 may also store instructions for the pressure transient analysis test tool 4 and/or the logging tools 10. The data storage 14 may also store relative permeability estimation instructions 16. The data storage 14 may also store values derived by the processor 17 from the available measurements (e.g., pressure transient analysis results, saturation analysis results, and porosity analysis results). In operation, the relative permeability estimation instructions 16 cause the processor 17 to estimate relative permeability values based on obtained pressure transient analysis results, obtained saturation analysis results, and obtained porosity analysis results as described herein.

At least some of the available measurements and/or derived values are provided to a telemetry module 18, which conveys the available measurements and/or derived values to earth's surface and/or to other downhole tools via an available telemetry channel compatible with the telemetry module 18. Example telemetry techniques include mud pulse telemetry, acoustic telemetry, electromagnetic telemetry (wired or wireless), or other known telemetry options. At earth's surface, the derived values (or related logs or images) are obtained as outputs from the downhole tool assembly 2. The outputs can be displayed using a display device (e.g., a computer or printer). As an option, the outputs can analyzed with or without involvement of a user. Additionally or alternatively, the outputs may be conveyed from the telemetry module 18 to another downhole tool configured to analyze the outputs and/or to perform one or more downhole operations in response to the outputs or commands derived therefrom. Regardless of whether the outputs are analyzed downhole or at earth's surface, various operations such as directional drilling operations, well completion operations, fluid flow control operations, and/or well intervention operations can be performed in response to the outputs or commands derived therefrom. In at least some embodiments, a set of logs can be provided to a customer. Example logs include, but are not limited to, oil/water relative permeability curves, oil/gas relative permeability curves, and gas/water relative permeability curves. Each logs may be associated with a particular borehole or region of a borehole.

As previously mentioned, the estimated relative permeability values can be reviewed/analyzed by individuals or teams that make decisions regarding hydrocarbon reservoir management. Example decision includes production management options, zone management options, and enhanced hydrocarbon recovery management options. Additionally or alternatively, at least some of the estimated relative permeability values can be provided as inputs to a reservoir simulator that predicts fluid flow. With or without user review/input, the reservoir simulator results and/or the estimated relative permeability values can also be used to adjust the operations of downhole components related to well completion, well intervention, and hydrocarbon production components. Example components that can be adjusted or directed based on the estimated relative permeability values or related results include directional drilling components, downhole logging tools, well completion tools, well intervention tools, sensors, valves, flow control components, pumps, etc.

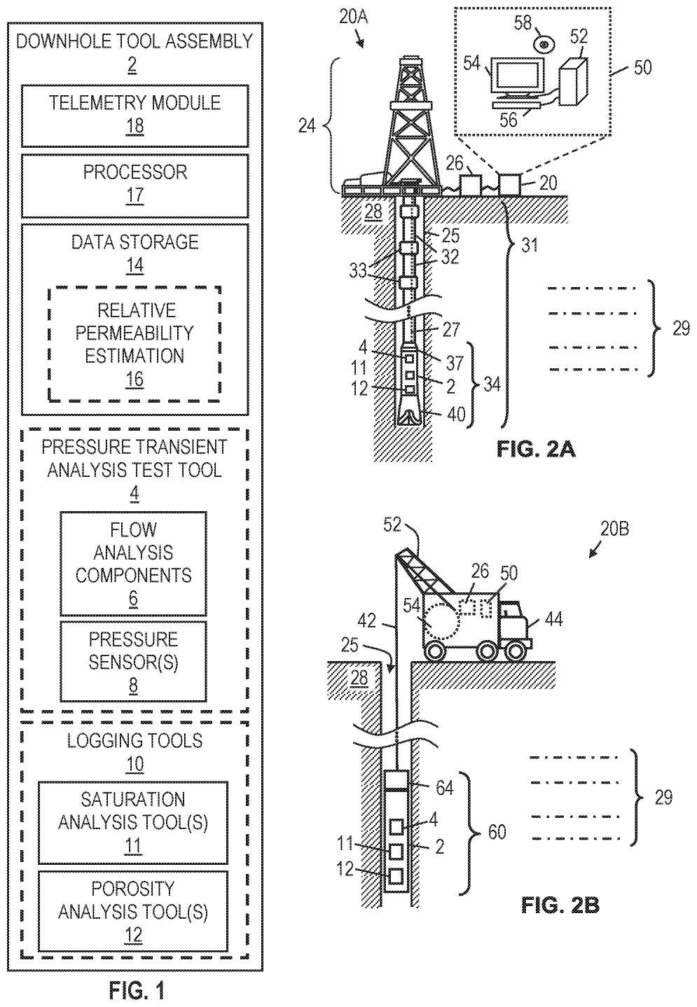

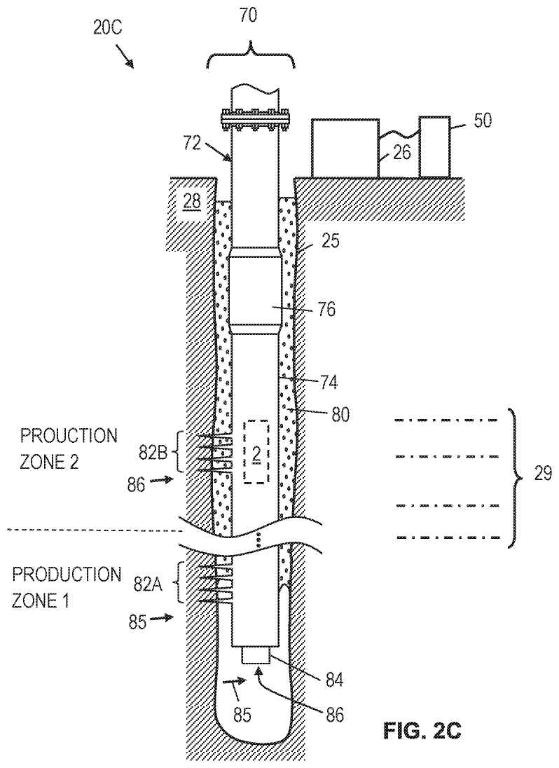

FIG. 2A is a schematic diagram showing an illustrative drilling survey environment 20A that may include a logging tool assembly 2. In FIG. 2A, a drilling assembly 24 enables a drill string 31 to be lowered and raised in a borehole 25 that penetrates formations 29 of the earth 28. The drill string 31 is formed, for example, from a modular set of drill string segments 32 and couplers 33. At the lower end of the drill string 31, a bottomhole assembly 34 with a drill bit 40 removes material from the formations 29 using known drilling techniques. The bottomhole assembly 34 also includes one or more drill collars 37 and downhole tool assembly 2. As previously described with respect to FIG. 1, the downhole tool assembly 2 includes a pressure transient analysis test tool 4, a saturation analysis tool 11, and a porosity analysis tool 12. Other logging tools may also be included. The pressure transient analysis test tool 4, the saturation analysis tool 11, and the porosity analysis tool 12 respectively obtain pressure transient analysis results, saturation analysis results, and porosity analysis results that are used to estimate relative permeability values as described herein.

In accordance with at least some embodiments, measurements obtained by the downhole tool assembly 2 are analyzed and derived parameters (e.g., pressure transient analysis results, saturation analysis results, porosity analysis results, and/or relative permeability values) are conveyed to earth's surface using known telemetry techniques (e.g., wired pipe telemetry, mud pulse telemetry, acoustic telemetry, electromagnetic telemetry) and/or are stored by the downhole tool assembly 2. In at least some embodiments, a cable 27 may extend from the BHA 34 to earth's surface. For example, the cable 27 may take different forms such as embedded electrical conductors and/or optical waveguides (e.g., fibers) to enable transfer of power and/or communications between the bottomhole assembly 34 and earth's surface. In different embodiments, the cable 27 may be integrated with, attached to, or inside the modular components of the drill string 31.

In FIG. 2A, an interface 26 at earth's surface receives the collected measurements and/or derived parameters via cable 27 or another telemetry channel and conveys the collected measurements and/or derived parameters to a computer system 50. In some embodiments, the surface interface 26 and/or the computer system 50 may perform various operations such as converting signals from one format to another and storing collected measurements and/or derived parameters. The computer system 50 also may operate to collect measurements and/or derived parameters to provide logs, images, or updated downhole formation models. Directional drilling operations and/or other downhole operations (e.g., fluid flow control, pressure control, valve position adjustment, logging tool updates) can be updated based on analysis of the collected measurements and/or derived parameters. In different embodiments, a user can interact with the computer system 50 to select analysis or response options (e.g., logs, images, directional drilling updates, downhole operation updates). Additionally or alternatively, analysis or response options can be automated (e.g., based on predetermined rules).

In at least some embodiments, the computer system 50 includes a processing unit 52 that performs relative permeability estimation operations or response operations by executing software or instructions obtained from a local or remote non-transitory computer-readable medium 58 (memory). The non-transitory computer-readable medium 58 may store, for example, instructions for the pressure transient analysis test tool 4 and/or the logging tools 10. The non-transitory computer-readable medium 58 may also store relative permeability estimation instructions (e.g., instructions 16), values derived by the processing unit 52 or processor 17 from the available measurements (e.g., pressure transient analysis results, saturation analysis results, and porosity analysis results). In operation, the relative permeability estimation instructions may cause the processing unit 52 to estimate relative permeability values based on obtained pressure transient analysis results, obtained saturation analysis results, and obtained porosity analysis results as described herein.

The computer system 50 also may include input device(s) 56 (e.g., a keyboard, mouse, touchpad, etc.) and output device(s) 54 (e.g., a monitor, printer, etc.). Such input device(s) 56 and/or output device(s) 54 provide a user interface that enables an operator to interact with the modular downhole tool 2 and/or software executed by the processing unit 52. For example, the computer system 50 may enable an operator to select test/logging options, to select test/data analysis options, to view obtained measurements, to view derived parameters (e.g., logs or images) obtained from the measurements, to adjust directional drilling, to adjust downhole operations, and/or to perform other tasks. Further, information about the downhole position at which measurements are obtained may be taken into account and used to facilitate well completion decisions and/or other strategic decisions related to producing hydrocarbons.

At various times during the drilling process, the drill string 31 shown in FIG. 2A may be removed from the borehole 25. With the drill string 31 removed, another option for deploying a modular downhole tool 2 involves the wireline survey environment 20B of FIG. 2B. In FIG. 2B, a tool string 60 is suspended in a borehole 25 that penetrates formations 29 of the earth 28. For example, the tool string 60 may be suspended by a cable 42 having conductors and/or optical fibers for conveying power to the tool string 60. The cable 42 may also be used as a communication interface for uphole and/or downhole communications. In at least some embodiments, the cable 42 wraps and unwraps as needed around cable reel 54 when lowering or raising the wireline tool string 60. As shown, the cable reel 54 may be part of a movable logging facility or vehicle 42 having a cable guide 52. In other embodiments, the tool string 60 can be deployed in the borehole 25 via slick line, coiled tubing, or tubular string.

In at least some embodiments, the tool string 60 includes a downhole tool assembly 2. As previously described with respect to FIG. 1, the downhole tool assembly 2 includes a pressure transient analysis test tool 4, a saturation analysis tool 11, and a porosity analysis tool 12. The tool string 60 may also include other tools or electronics 64. The measurements collected by the downhole tool assembly 2 are conveyed to earth's surface and/or are stored by the tool string 60. In either case, the measurements can be used to derive parameters related to pressure transient analysis results, saturation analysis results, and porosity analysis results. Also, relative permeability values can be estimated as described herein.

At earth's surface, a surface interface 26 receives collected measurements and/or derived parameters via the cable 42 and conveys the collected measurements and/or derived parameters to a computer system 50. As previously discussed, the interface 26 and/or computer system 50 (e.g., part of the movable logging facility or vehicle 44) may perform various operations such as converting signals from one format to another and storing collected measurements and/or derived parameters. The computer system 50 also may operate to analyze collected measurements and/or derived parameters to provide logs, images, updated downhole formation models, simulation inputs, or other uses. As an example, the derived parameters may correspond to pressure transient analysis results, saturation analysis results, porosity analysis results, relative permeability values, and/or other values. Related logs or images can be displayed and/or provided to a customer. With or without user input, the derived parameters can be used to adjust ongoing or future downhole operations in borehole 25 or a related reservoir.

FIG. 2C shows a permanent well survey environment 20C, where a downhole tool assembly 2 (e.g., the downhole tool assembly of FIG. 1) is deployed in a permanent well 70 to estimate relative permeability values as described herein. In the permanent well survey environment 20C, a drilling rig has been used to drill a borehole 25 that penetrates formations 29 of the earth 28 in a typical manner (see e.g., FIG. 2A). Further, a casing string 72 is positioned in the borehole 25. The casing string 72 of well 70 includes multiple tubular casing sections 74 (usually about 30 feet long) connected end-to-end by couplings 76. It should be noted that FIG. 2C is not to scale, and that casing string 72 typically includes many such couplings 76. Further, the well 70 may include cement 80 to hold the casing string 72 in place and prevent flow through the annular space. The cement 80 is provided, for example, by injecting cement slurry into the annular space between the outer surface of the casing string 72 and the inner surface of the borehole 25, and by allowing the cement slurry to set. Further, a production tubing string 84 has been positioned in an inner bore of the casing string 72.

The well 70 is adapted to guide a desired fluid (e.g., oil or gas) from at least one production zone (e.g., production zones 1 and 2 are represented) of the borehole 25 to a surface of the earth 28. As desired, perforations 82A and 82B are provided for the different production zones to facilitate the flow of fluids from a surrounding formation into the borehole 25 and thence to earth's surface. For example, production of fluid 85 related to production zone 1 may involve the fluid 85 entering the production tubing 84 or casing string 72 via perforations 82A and/or via an opening 86 in the production tubing 84 at the bottom of the well 70. In contrast, fluids 86 related to production zone 2 may enter the casing string 72 and/or the production tubing 84 via perforations 82B. The different production zones can be merged together or can be isolated as desired. Note that this well configuration is illustrative and not limiting on the scope of the disclosure.

Depending on the particular survey environment, pressure transient analysis operations, saturation analysis operations, porosity analysis operations, and related tools may vary. Regardless of such variations, the concepts of using pressure transient analysis results, saturation analysis results, and porosity analysis results to estimate relative permeability values as described herein is possible.

A brief description of different options for estimating relative permeability values follows. The discussion below is intended to at least provide an understanding of relative permeability estimation options, and is not intended to limit the disclosure to a particular embodiment. There are at least two types of pressure transient analysis test tools that can be used to estimate relative permeability as described herein. One type of pressure transient analysis test tool is referred to as a formation tester. For example, formation testers can be used for pressure transient analysis operations in a drilling survey scenario (FIG. 2A) or a wireline survey scenario (FIG. 2B). The other type of pressure transient analysis test tool is referred to as a production logger. Production loggers can be used for pressure transient analysis operations in a permanent well survey scenario (FIG. 2C). Another pressure transient analysis test tool is referred to as a mini drillstem tester (mini-DST).

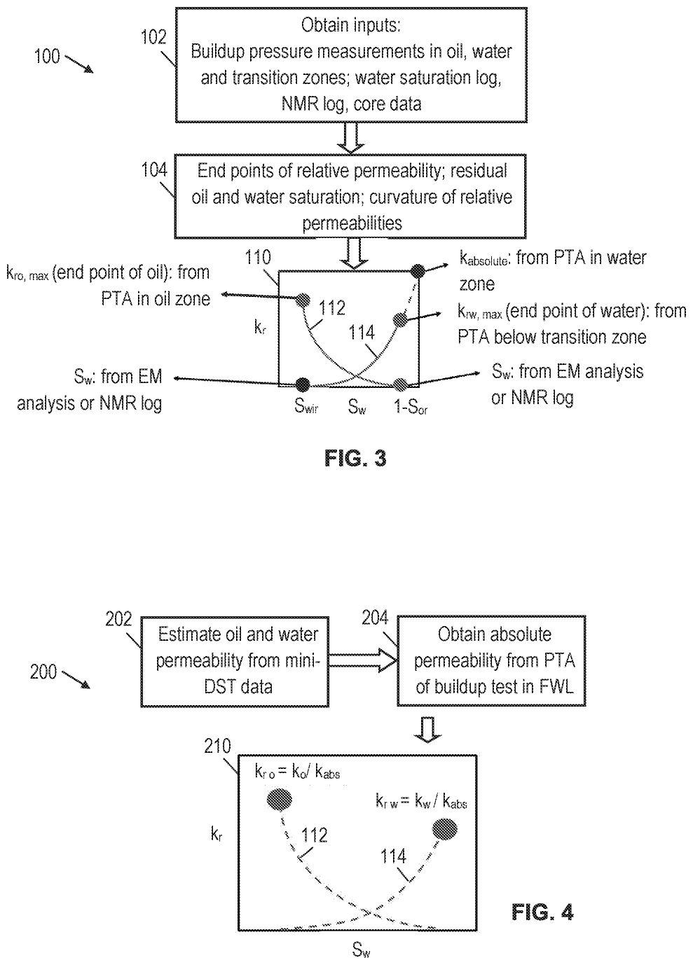

FIG. 3 is a flowchart 100 showing an illustrative option for relative permeability estimation. In flowchart 100, various inputs are obtained at block 102. Example inputs for block 102 include buildup pressure measurements in oil, water, and transition zones (e.g., from a pressure transient analysis test tool). Another input for block 102 includes a water saturation log (e.g., from a saturation analysis tool). Another input for block 102 includes an NMR log or another porosity analysis tool log. Another optional input for block 102 includes core data (e.g., special core analysis or “SCAL” data). Core data can be used to obtain the curvature of relative permeability curve if there is no transition zone. In addition, core data can provide relative permeability end points if there is not a pure water, pure gas, or pure oil zone available. To extract a core, a rotary sidewall core tool is deployed downhole take a core from the reservoir. The core is then analyzed at earth's surface (e.g., in a laboratory). At block 104, various values are determined based on the inputs obtained at block 102. For example, the determined values of block 104 may include end points of relative permeability (e.g., kᵣₒ and k_{rw}). More specifically, an oil permeability end point can be determined from pressure transient analysis (PTA in FIG. 3) performed in an oil zone. Meanwhile, a water permeability end point can be determined from pressure transient analysis performed below an oil/water transition zone (where water purity is higher). Also, an absolute permeability end point can be determined from pressure transient analysis performed in a water zone (i.e., in the free water level). With these various values, relative permeability curves 112 and 114 can be accurately determined as shown in chart 110. If determining the absolute permeability is not feasible, relative permeability curves can be normalized by the end-point of oil permeability.

In at least some embodiments, determining the residual water and oil values mentioned for block 104 of flowchart 100 involves water saturation measurements from resistivity-based logs and/or NMR logs. Water saturation in the oil zone indicates residual water and residual oil is calculated from water saturation below oil-water contact. If the only available mini-DST was in the transition zone, relative permeability curves can still be determined.

The flowchart 200 of FIG. 4 shows an illustrative option for determining end-points of relative permeability curves 112 and 114 from formation tester measurements. In flowchart 200, oil and water permeability values are determined from mini drillstem test data at block 202. At block 204, an absolute permeability value is obtained from pressure transient analysis of buildup test in a water zone (i.e., in the free water level). The determined end-points related to flowchart 200 are represented in graph 210. Again, these end-points can be used to help determine relative permeability curves 112 and 114. For example, dividing the oil and water permeabilities by an absolute permeability can be used to determine the relative permeability curves 112 and 114.

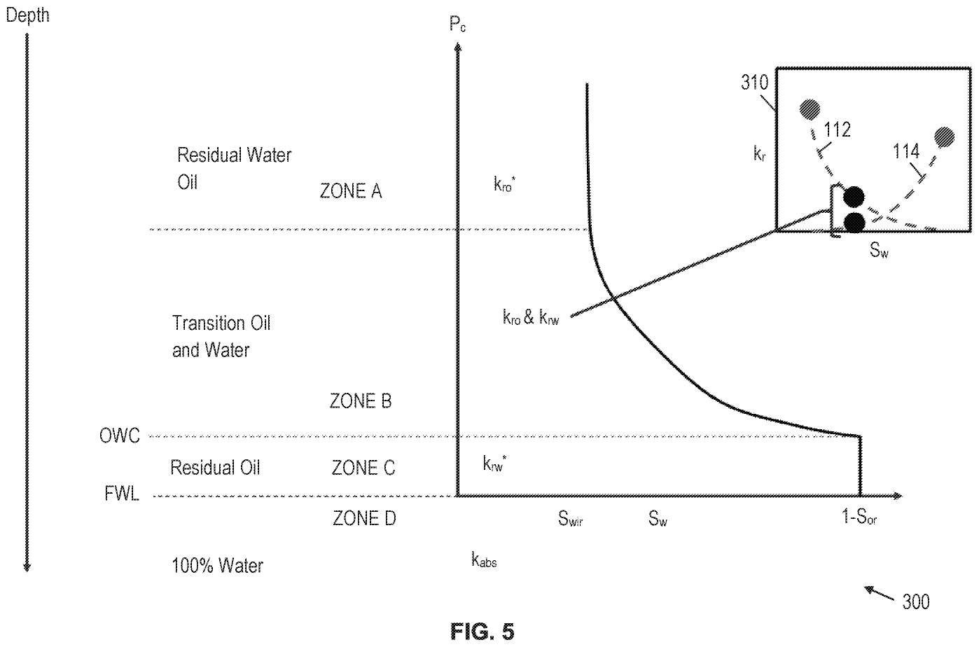

FIG. 5 shows a graph 300 that represents different zones as a function of depth. Zone A is the highest zone represented and includes residual water and oil. Zone B includes transition oil and water. Zone C includes residual oil. The boundary between Zones B and C is referred to as the oil-water contact (OWC). Zone D includes 100% water. The boundary between Zones C and D is the free water level (FWL). In FIG. 5, a representation of using relative permeability values of oil and water obtained from the transition zone to build relative permeability curves 112 and 114 is provided. More specifically, relative permeability values obtained from the transition zone are extrapolated to the residual water and oil to find the end points of relative permeabilities as shown in graph 310. Increasing the number of mini-DST measurements in the transition zone will bring more confidence to the resulting relative permeability curves 112 and 114.

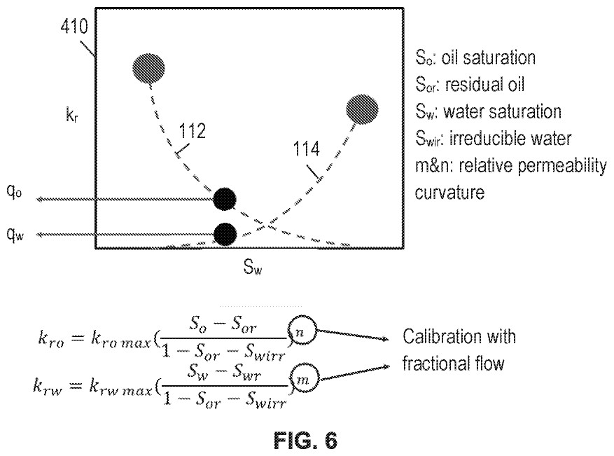

In high permeability formations, where there is no transition zone, history matching of pressure data can be performed to estimate the curvature of the relative permeability curves 112 and 114. FIG. 6 shows a representation of estimating relative permeability curvatures 112 and 114 from mini-DST measurements in a transition zone. Graph 410 of FIG. 6 shows relative permeability points along curves 112 and 114, where relative permeability points are calculated at least in part using the formulas given for kᵣₒ and k_{rw} in FIG. 6, and where the curvature for the curves 112 and 114 is determined at least in part from a calibration operation involving fractional flow. Fractional flow provides the ratio of oil and water flow rate. Testing the formation in transition zone provides flow rates of oil and water. Knowing the flow rates and effective permeability to oil and water, curvature of relative permeability curves can be produced and the value of m and n in the model can be obtained.

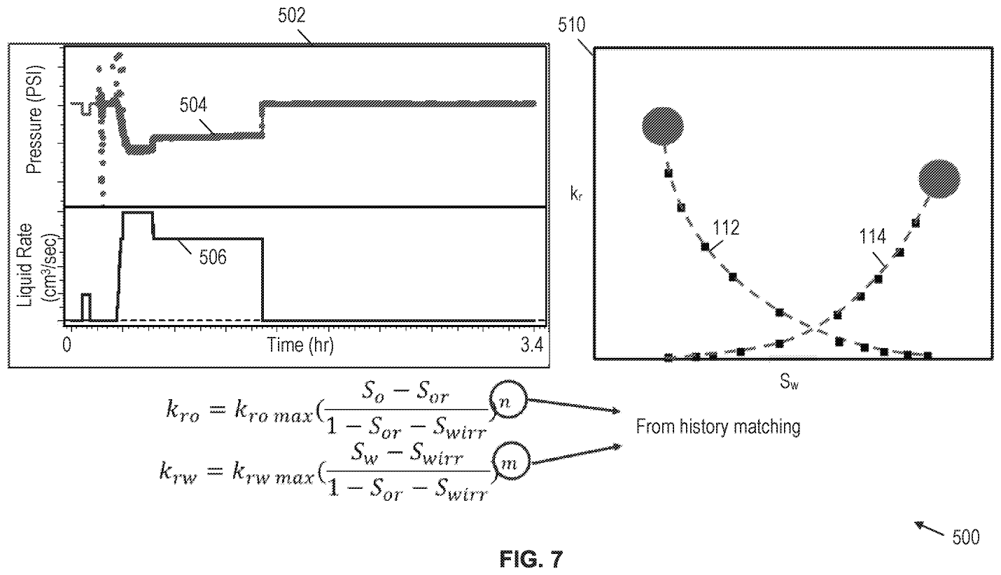

Meanwhile, FIG. 7 shows a representation of using history matching of pressure measurements to determine points along the relative permeability curves 112 and 114. In chart 502, pressure measurements 504 and liquid rate measurements 506 are represented as a function of time. Graph 510 of FIG. 7 shows relative permeability points along curves 112 and 114, where the relative permeability points are calculated at least in part using the formulas given for kᵣₒ and k_{rw} in FIG. 7, and where the curvature for the curves 112 and 114 is determined at least in part from history matching operations.

Table 1 shows a summary of relative permeability estimation options based on formation tester measurements.

TABLE 1

| | Relative Permeability Estimation |
|---|---|
| Inputs | Pumpout pressure measurements in oil, water and |
| | transition zones, water saturation log, and NMR log |
| Deliverable | Relative permeability curves |
| Unknowns | k_{absolute}, k_{ro, max}, k_{rw, max}, Sₒᵣ, S_{wirr}, n, and m |
| to be | |
| determined | |
| Uncertainty | Curvature of relative permeability when transition |
| | zone is small or formation permeability is very large. |

The main uncertainty for relative permeability estimation based on formation tester measurements is the curvatures of the relative permeabilities when the transition zone is small. As needed, a history matching of pressure measurements can be used in oil or water zone analysis depending on the type of mud filtrate to obtain the relative permeability curvatures.

Another relative permeability estimation option involves injecting the water or water base mud (WBM) filtrate into the formation in an oil zone, and subsequently pumping out once a sufficient injection has been carried out. For example, a straddle packer may be used to pump mud filtrate into an oil or water zone and flow back the fluid. These injection operations provide downhole core flooding corresponding to a transition zone from which relative permeability values can be obtained to ensure accuracy of the relative permeability curvatures 112 and 114.

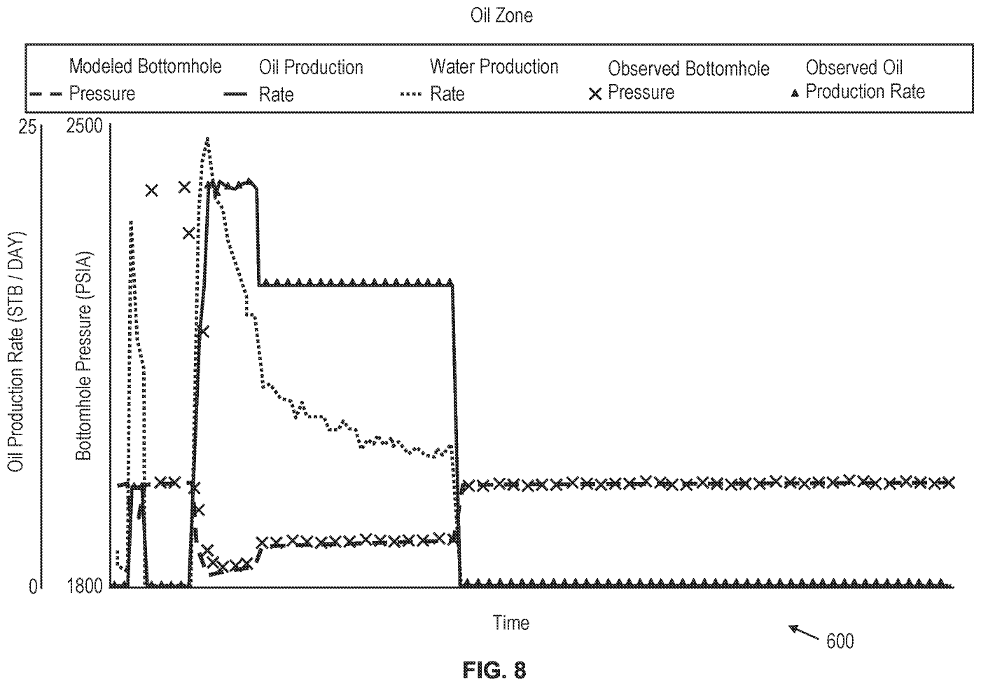

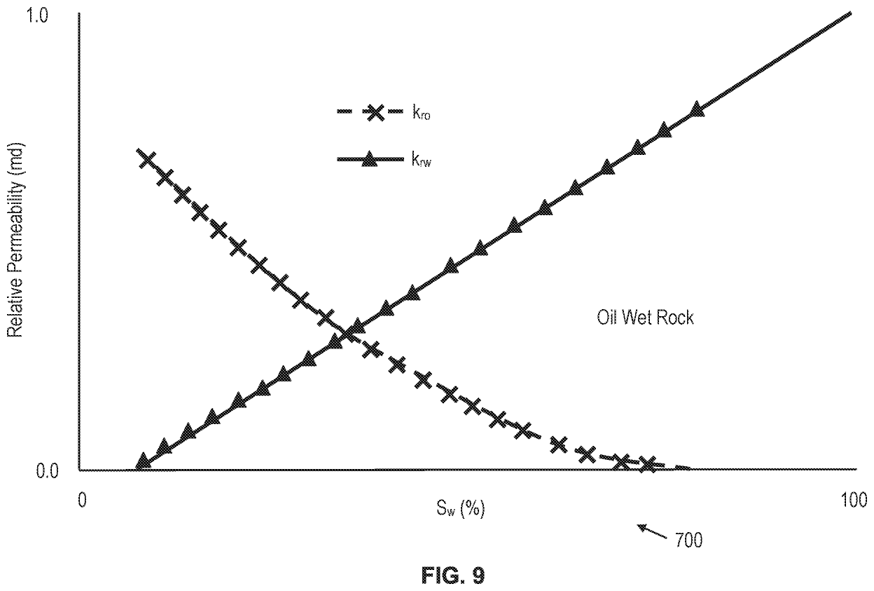

In at least some embodiments, the depth of invasion can be estimated after injection operations from either resistivity based measurements, NMR, dielectric or a combination of available log data. Using this estimated depth of invasion, the pressure transient analysis operations can be history matched for relative permeability estimation by constraining the rate and observing the pressure and water cut as shown in FIGS. 8 and 9. In FIG. 8, chart 600 shows modeled bottomhole pressure values, oil production rate values, water production rate values, observed bottomhole pressure values, and observed oil production rate values as a function of time. Observed water cut values and pressure values such as those represented in chart 600 of FIG. 8 can be used to estimate relative permeability values as a function of water saturation as shown in chart 700 of FIG. 9. In another embodiment, pressure transient analysis operations can be history matched for relative permeability estimation using Oil Based Mud (OBM) in a water zone.

In different embodiments, relative permeability estimation may vary depending on characteristics of the formation. For example, the relative permeability estimation options represented for FIGS. 3-9 may be applicable to formations with massive sandstone of high permeability and medium quality oil. These same options may also be suitable for fractured and non-fractured carbonate formations. For a scenario with sand-shale, good permeability, and medium to heavy oils, relative permeability estimation may involve applying a Leverett J-function. In this manner, a facies with known relative permeability curves can be used to obtain the relative permeability curves in another zone with known porosity and permeability. While the options described for FIGS. 3-9 are directed to estimating oil/water relative permeability curves, it should be appreciated that similar techniques can be used to estimate oil/gas permeability curves or gas/water permeability curves.

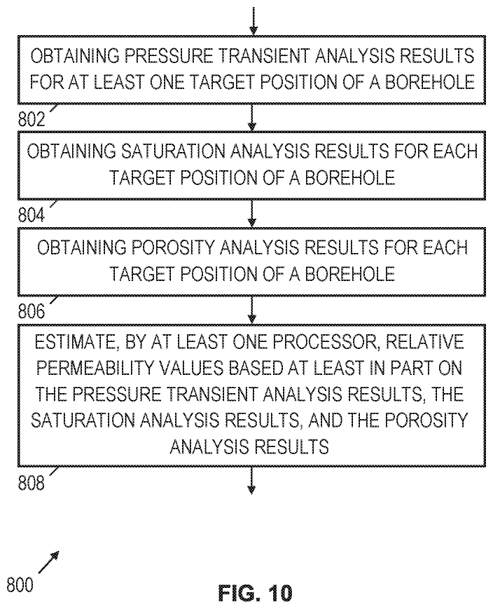

FIG. 10 is a flowchart showing an illustrative method 800 for relative permeability estimation. At block 802, the method 800 includes obtaining pressure transient analysis results for at least one target position in a borehole. The operations of block 802 may involve different types of pressure transient analysis test tools and may involve openhole operations and/or cased-hole operations as described herein. At block 804, saturation analysis results are obtained for each target position. At block 806, porosity analysis results are obtained for each target position. Different types of saturation analysis tools and porosity analysis tools are possible. Example saturation analysis tools include EM analysis tools such as resistivity logging tools or dielectric logging tools. Meanwhile, example porosity analysis tools include NMR logging tools or neutron density logging tools. At block 808, relative permeability values are estimated based at least in part on the pressure transient analysis results, the saturation analysis results, and the porosity analysis results. Various relative permeability estimation options are represented and discussed in FIGS. 3-9. The result of the relative permeability estimation of block 806 may be, for example, oil/water relative permeability curves, oil/gas permeability curves, and/or gas/water permeability curves. The estimated relative permeability values are output (e.g., displayed, used as inputs to a simulator, or used to control surface or downhole operations). In different embodiments, relative permeability estimation involves at least one downhole processor and memory (e.g., processor 17 and data storage 14 of the logging tool assembly 2). Additionally or alternatively, relative permeability estimation may involve at least one computer processor and memory at earth's surface (e.g., processing unit 52 and non-transitory computer-readable medium 58 of computer system 50). The downhole and/or surface memories used may store instructions for the pressure transient analysis test tool 4 and/or the logging tools 10. Also, downhole and/or surface memories may store relative permeability estimation instructions. Also, downhole and/or surface memories may store values derived by one or more processors from the available measurements (e.g., pressure transient analysis results, saturation analysis results, and porosity analysis results). In operation, relative permeability estimation instructions cause downhole and/or surface processors to estimate relative permeability values based on obtained pressure transient analysis results, obtained saturation analysis results, and obtained porosity analysis results as described herein.

Embodiments disclosed herein include:

A: A system that comprises a pressure transient analysis test tool configured to obtain downhole pressure transient analysis results for at least one target position of a borehole, the pressure transient analysis test tool having at least one flow analysis component and at least one pressure sensor. The downhole pressure transient analysis results are based on fluid flow rate measurements collected by the at least one flow analysis component for each target position and are based on pressure measurements collected by the at least one pressure sensor for each target position. The system also comprises at least one memory that stores relative permeability estimation instructions, the pressure transient analysis results, saturation analysis results for each target position, and porosity analysis results for each target position. The system also comprises at least one processor in communication with the at least one memory, wherein the relative permeability estimation instructions cause the at least one processor to estimate relative permeability values based at least in part on the pressure transient analysis results, the saturation analysis results, and the porosity analysis results.

B: A method that comprises obtaining pressure transient analysis results for at least one target position of a borehole. The method also comprises obtaining saturation analysis results for each target position. The method also comprises obtaining porosity analysis results for each target position. The method also comprises estimating, by at least one processor, relative permeability values based at least in part on the pressure transient analysis results, the saturation analysis results, and the porosity analysis results.

C: A system that comprises a processor and at least one memory in communication with the processor and storing relative permeability estimation instructions, pressure transient analysis results for at least one target position of a borehole, saturation analysis results for each target position, and porosity analysis results for each target position. The relative permeability estimation instructions cause the processor to estimate relative permeability curves based at least in part on the pressure transient analysis results, the saturation analysis results, and the porosity analysis results. The system also comprises an output that displays the estimated relative permeability curves.

Each of the embodiments, A, B, and C, may have one or more of the following additional elements in any combination. Element 1: wherein the at least one target position corresponds to an identified oil zone, an identified water zone, and an identified oil/water transition zone. Element 2: wherein the at least one target position corresponds to an identified oil zone, an identified gas zone, and an identified oil/gas transition zone. Element 3: wherein the at least one target position correspond to an identified gas zone, an identified water zones, and an identified gas/water zone. Element 4: further comprising an saturation analysis tool deployed in the borehole to obtain the saturation analysis results, wherein the saturation analysis tool is deployed simultaneously in the borehole with the pressure transient analysis test tool. Element 5: wherein the saturation analysis tool comprises at least one of a resistivity logging tool and a dielectric analysis logging tool. Element 6: further comprising a porosity analysis tool deployed in the borehole to obtain the porosity analysis results, wherein the porosity analysis tool is deployed simultaneously in the borehole with the pressure transient analysis test tool. Element 7: wherein the porosity analysis tool comprises at least one of a NMR logging tool and a neutron density logging tool. Element 8: wherein the pressure analysis test tool performs injection operations for at least one target position to create a transition zone before collecting pressure measurements and fluid flow rate measurements. Element 9: further comprising an output that displays the relative permeability values.

Element 10: further comprising identifying a hydrocarbon zone, a hydrocarbon/water transition zone, and a water zone as the at least one target position. Element 11: further comprising deploying a saturation analysis tool and a porosity analysis tool in the borehole to obtain the saturation analysis results and a porosity analysis results for each target position Element 12: further comprising performing injection operations for at least one target position to create a transition zone before obtaining the pressure transient analysis results. Element 13: further comprising displaying the estimated relative permeability values.

Element 14: wherein the pressure transient analysis results include pressure change values for each target position, wherein the saturation analysis results include saturation levels for each target position, wherein the porosity analysis results include a porosity value for each target position, and wherein the relative permeability estimation instructions cause the processor to apply the pressure change values, the saturation levels, and the porosity values to a multi-phase flow model to estimate the relative permeability curves. Element 15: wherein the relative permeability estimation instructions cause the processor to estimate the relative permeability curves based at least in part on hydrocarbon permeability end points obtained from analysis results for a hydrocarbon zone corresponding to one of the target positions. Element 16: wherein the relative permeability estimation instructions cause the processor to estimate the relative permeability curves based at least in part on water permeability end points obtained from analysis results for a water zone corresponding to one of the target positions. Element 17: wherein the relative permeability estimation instructions cause the processor to estimate the relative permeability curves based at least in part on permeability curvature points obtained from analysis results for a transition zone corresponding to one of the target positions.

Numerous other variations and modifications will become apparent to those skilled in the art once the above disclosure is fully appreciated. It is intended that the following claims be interpreted to embrace all such variations and modifications where applicable.

1. A system that comprises:
a pressure transient analysis test tool configured to obtain downhole pressure transient analysis results for at least one target position of a borehole, the pressure transient analysis test tool having at least one flow analysis component and at least one pressure sensor, wherein the downhole pressure transient analysis results are based on fluid flow rate measurements collected by the at least one flow analysis component for each target position and are based on pressure measurements collected by the at least one pressure sensor for each target position; and
at least one memory that stores relative permeability estimation instructions, the pressure transient analysis results, saturation analysis results for each target position, and porosity analysis results for each target position; and
at least one processor in communication with the at least one memory, wherein the relative permeability estimation instructions cause the at least one processor to estimate relative permeability values based at least in part on the pressure transient analysis results, the saturation analysis results, and the porosity analysis results.

2. The system of claim 1, wherein the at least one target position corresponds to an identified oil zone, an identified water zone, and an identified oil/water transition zone.

3. The system of claim 1, wherein the at least one target position corresponds to an identified oil zone, an identified gas zone, and an identified oil/gas transition zone.

4. The system of claim 1, wherein the at least one target position correspond to an identified gas zone, an identified water zones, and an identified gas/water zone.

5. The system of claim 1, further comprising a saturation analysis tool deployed in the borehole to obtain the saturation analysis results, wherein the saturation analysis tool is deployed simultaneously in the borehole with the pressure transient analysis test tool.

6. The system of claim 5, wherein the saturation analysis tool comprises at least one of a resistivity logging tool and a dielectric analysis logging tool.

7. The system of claim 1, further comprising a porosity analysis tool deployed in the borehole to obtain the porosity analysis results, wherein the porosity analysis tool is deployed simultaneously in the borehole with the pressure transient analysis test tool.

8. The system of claim 7, wherein the porosity analysis tool comprises at least one of a nuclear magnetic resonance (NMR) logging tool and a neutron density logging tool.

9. The system of claim 1, wherein the pressure analysis test tool performs injection operations for at least one target position to create a transition zone before collecting pressure measurements and fluid flow rate measurements.

10. The system according to claim 1, further comprising an output that displays the relative permeability values.

11. A method that comprises:
obtaining pressure transient analysis results for at least one target position of a borehole;
obtaining saturation analysis results for each target position;
obtaining porosity analysis results for each target position;
estimating, by at least one processor, relative permeability values based at least in part on the pressure transient analysis results, the saturation analysis results, and the porosity analysis results.

12. The method of claim 11, further comprising identifying a hydrocarbon zone, a hydrocarbon/water transition zone, and a water zone as the at least one target position.

13. The method of claim 11, further comprising deploying a saturation analysis tool and a porosity analysis tool in the borehole to obtain the saturation analysis results and the porosity analysis results for each target position.

14. The method of claim 11, further comprising performing injection operations for at least one target position to create a transition zone before obtaining the pressure transient analysis results.

15. The method according to claim 11, further comprising displaying the estimated relative permeability values.

16. A system that comprises:
a processor;
at least one memory in communication with the processor and storing relative permeability estimation instructions, pressure transient analysis results for at least one target position of a borehole, saturation analysis results for each target position, and porosity analysis results for each target position,
wherein the relative permeability estimation instructions cause the processor to estimate relative permeability curves based at least in part on the pressure transient analysis results, the saturation analysis results, and the porosity analysis results; and
an output that displays the estimated relative permeability values.

17. The system of claim 16, wherein the pressure transient analysis results include pressure change values for each target position, wherein the saturation analysis results include saturation levels for each target position, wherein the porosity analysis results include a porosity values for each target position, and wherein the relative permeability estimation instructions cause the processor to apply the pressure change values, the saturation levels, and the porosity values to a multi-phase flow model to estimate the relative permeability curves.

18. The system of claim 16, wherein the relative permeability estimation instructions cause the processor to estimate the relative permeability curves based at least in part on hydrocarbon permeability end points obtained from analysis results for a hydrocarbon zone corresponding to one of the target positions.

19. The system of claim 16, wherein the relative permeability estimation instructions cause the processor to estimate the relative permeability curves based at least in part on water permeability end points obtained from analysis results for a water zone corresponding to one of the target positions.

20. The system of claim 16, wherein the relative permeability estimation instructions cause the processor to estimate the relative permeability curves based at least in part on permeability curvature points obtained from analysis results for a transition zone corresponding to one of the target positions.
